(19) United States
(12) Patent Application Publication
(10) Pub. No.: US 2009/0109448 A1
(43) Pub. Date: Apr. 30, 2009

(54) ELECTROSTATIC CHARGE IMAGE DEVELOPING CARRIER, ELECTROSTATIC CHARGE IMAGE DEVELOPER, ELECTROSTATIC CHARGE IMAGE DEVELOPER CARTRIDGE, PROCESS CARTRIDGE, IMAGE FORMING METHOD AND IMAGE FORMING APPARATUS

(75) Inventors: Fusako Kiyono, Kanagawa (JP); Taichi Yamada, Kanagawa (JP); Yosuke Tsurumi, Kanagawa (JP); Akira Matsumoto, Kanagawa (JP); Akihiro Iizuka, Kanagawa (JP); Tsuyoshi Murakami, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/166,975

(22) Filed: Jul. 2, 2008

(30) Foreign Application Priority Data
Oct. 25, 2007 (JP) 2007-277928

(51) Int. Cl. G06F 3/12; G03G 9/083

(52) U.S. Cl. 358/1.1; 430/108.2; 430/108.9

(57) ABSTRACT

An electrostatic charge image developing carrier includes: a magnetic particle; and a resin coating layer that covers a surface of the magnetic particle with a resin, the resin coating layer containing an acid having a cyclic diterpene structure and either of carbon black or nigrosine dispersed therein.

### CROSS-REFERENCE TO RELATED APPLICATION

This application is based on and claims priority under 35 USC 119 from Japanese Patent Application No. 2007-277928, filed Oct. 25, 2007.

### BACKGROUND

1. Technical Field

The present invention relates to a carrier for development of an electrostatic image, and to a developer for development of an electrostatic charge image, an electrostatic charge image developer cartridge, a process cartridge, an image forming method, and an image forming apparatus using the same.

2. Related Art

A method of forming image information as an image through an electrostatic latent image such as an electrophotography method is utilized in various fields at present. In the electrophotography method, an electrostatic latent image formed via a charging step and an exposing step on a photoreceptor is developed as a toner image by a developer containing a toner and, subsequently an image is formed from the toner image via a transfer step and a fixing step.

Two component developers containing a toner and a carrier and single component developers such as a magnetic toner that is used singly exist as developers used for developing. In the two component developers, the carrier performs functions such as agitation, transportation and charging of the developer, and since the functions of the developer are separated and divided between the toner and the carrier, two-component developers have excellent controllability and are used widely at present.

In particular, developers that use a carrier (resin-coating carrier) in which a surface of a magnetic particle is covered by a covering layer mainly containing a resin display excellent charge controllability and it is relatively easy to reduce the sensitivity to ambient conditions and improve the storage stability thereof. Further, although a cascade process or the like was used in the past, a magnetic brush process that uses a magnetic roll as a developers conveyor is mainly used as the developing process at present.

### SUMMARY

According to an aspect of the invention, there is provided an electrostatic charge image developing carrier including a magnetic particle and a resin coating layer that covers a surface of the magnetic particle with a resin, the resin coating layer containing an acid having a cyclic diterpene structure and either of carbon black or nigrosine dispersed therein.

### BRIEF DESCRIPTION OF THE DRAWINGS

Exemplary embodiments of the present invention will be described in detail based on the following drawings, wherein:

FIG. 1 is a schematic configurational view showing an example of an image forming apparatus according to an aspect of the invention; and

FIG. 2 is a schematic configurational view showing an example of a process cartridge according to an aspect of the invention.

### DETAILED DESCRIPTION

(Electrostatic Charge Image Developing Carrier)

An exemplary embodiment of an electrostatic charge image developing carrier of the invention includes a magnetic particle and a resin coating layer coating a surface of the magnetic particle with a resin, and the resin coating layer contains an acid having a cyclic diterpene structure and either of carbon black or nigrosine dispersed therein. or nigrosine dispersed therein.

The carrier having the resin coating layer where the acid having the cyclic diterpene structure and carbon black are dispersed in the resin coating layer is called a first exemplary embodiment of the electrostatic charge image developing carrier of the invention (also referred to hereinafter as “the first exemplary embodiment of the invention”) and the carrier having the resin coating layer where the acid having the cyclic diterpene structure and nigrosine are dispersed in the resin coating layer is called a second exemplary embodiment of the electrostatic charge image developing carrier of the invention (also referred to hereinafter as “the second exemplary embodiment of the invention”).

In the beginning, the resin coating layer in the exemplary embodiment of the carrier of the invention (Hereinafter, the resin coating layer in which carbon black is dispersed is also referred to as “the first exemplary embodiment of a resin coating layer” and the resin coating layer in which nigrosine is dispersed is also referred to as “the second exemplary embodiment of the resin coating layer”.) will be described.

In the exemplary embodiment of the resin coating layer, an acid having a cyclic diterpene structure and either of carbon black or nigrosine are dispersed in a resin.

Examples of the acid having a cyclic diterpene structure used in the exemplary embodiment include abietic acid, neoabietic acid, pimaric acid and dehydrosapietic acid, and, among these, abietic acid is preferable. Furthermore, only a single acid having a cyclic diterpene structure may be used, or two or more acids having a cyclic diterpene structure may be used in combination.

Furthermore, examples of carbon black used in the first exemplary embodiment of the resin coating layer include ketchen black and furnace black.

In the next place, a method for dispersing carbon black together with an acid having a cyclic diterpene structure in the resin will be described.

Since an acid having a cyclic diterpene structure does not dissolve in water, it may be dispersed in a strong alkali solution (preferably pH 11 to 13) to form an alkali metal salt. The alkali metal salt easily adheres to a surface of carbon black. Accordingly, when the alkali metal salt is pulverized under an alkali condition with a ball mill or the like, carbon black and the alkali metal salt readily adhere to each other.

The carbon black having the alkali metal salt adhered thereto is readily dispersed because acid molecules having a cyclic diterpene structure tend to repel each other.

When the carbon black having the alkali metal salt adhered thereto is neutralized, carbon black having the acid with a cyclic diterpene structure adhered to surface thereof is obtained.

In an example of a method of neutralizing the carbon black having the alkali metal salt adhered thereto, a mineral acid (for example, nitric acid, sulfuric acid, or hydrochloric acid) is added to adjust the pH to about 7, and then water is removed.

In the first exemplary embodiment of the resin coating layer, from the viewpoint of being capable of obtaining sufficient charging and a sharper charge distribution, the content of carbon black in the resin coating layer is preferably from 0.2% by weight to 10% by weight relative to the amount of the coating resin and more preferably from 1% by weight to 5% by weight relative to the amount of the coating resin.

Furthermore, in the first exemplary embodiment of the resin coating layer, from the viewpoints of being able to sufficiently disperse carbon black and making re-aggregation less likely to occur, the content of the acid having a cyclic diterpene structure in the resin coating layer is preferably from 20% by weight to 80% by weight relative to the amount of carbon black and more preferably from 40% by weight to 70% by weight relative to the amount of carbon black.

In the first exemplary embodiment of the resin coating layer, the resin covering the surface of the magnetic particle preferably contains a resin having a cycloalkyl group at a side chain from the viewpoint of obtaining enhanced effects at high temperature and high humidity due to a hydrophobic effect caused by the cyclohexyl group. Furthermore, the resin having a cycloalkyl group at a side chain is preferably selected from the group consisting of cyclohexyl acrylate, cyclohexyl methacrylate and cyclohexyl ethacrylate. Only a single resin selected from these resins may be used, or alternatively, two or more of these resins may be used in combination.

The relationship between the number average particle diameter of the carbon black d₁ (μm) and the mean spacing of profile irregularities on the surface of the magnetic particle Sm satisfies preferably 0.4Sm (or about 0.4Sm)≦d₁≦2Sm (or about 2Sm) and more preferably 0.4 Sm (or about 0.4Sm)≦d₁≦1.5Sm (or about 1.5Sm). If d₁ exceeds 2Sm, the magnetic particle may be exposed when a resin coating layer is worn. On the other hand, if d₁ is less than 0.4Sm, separation of carbon black or nigrosine may occur since carbon black or nigrosine may not be sufficiently fixed at the recess of the magnetic particle.

The number average particle diameter d₁ of the carbon black is preferably from 0.1 μm (or about 0.1 μm) to 1 μm (or about 1 μm), more preferably from 0.1 μm (or about 0.1 μm) to 0.9 μm (or about 0.9 μm), and still more preferably from 0.1 μm (or about 0.1 μm) to 0.8 μm (or about 0.8 μm) from the viewpoint of improving the strength of the resin coating layer. The number average particle diameter d₁ of the carbon black may be measured by measuring the maximum particle diameter of each of 100 carrier particles based on TEM photographs of the carrier cross sections, and averaging the maximum particle diameters.

In the next place, the resin coating layer in the second exemplary embodiment of the carrier of the invention will be described.

In the second exemplary embodiment of the resin coating layer, an acid having a cyclic diterpene structure and nigrosine are dispersed in a resin.

The acid having a cyclic diterpene structure that is used in the exemplary embodiment is same as the acid having a cyclic diterpene structure used in the first exemplary embodiment of the resin coating layer, and preferable examples as well are same.

The method of dispersing nigrosine together with the acid having a cyclic diterpene structure in the resin is same as the method of dispersing carbon black together with the acid having a cyclic diterpene structure in the resin. This is because the two methods use the same principles.

Furthermore, in the second exemplary embodiment of the resin coating layer as well, it is preferable to neutralize nigrosine to which the alkali metal salt adheres.

In the second exemplary embodiment of the resin coating layer, from the viewpoint of obtaining a sufficient charge amount and a sharper charge amount distribution, the content of nigrosine in the resin coating layer is, relative to the amount of the acid having a cyclic diterpene structure, from 10% by weight to 70% by weight and more preferably from 30% by weight to 60% by weight.

In the second exemplary embodiment of the resin coating layer, from the viewpoints of being able to sufficiently disperse nigrosine and being able to obtain a preferable charge amount without disturbing the charging property intrinsic to nigrosine, the content of the acid having a cyclic diterpene structure in the resin coating layer is, relative to the amount of the coating resin, preferably from 2% by weight to 40% by weight and more preferably from 0.5% by weight to 20% by weight.

The resin that covers the surface of the magnetic particle in the second exemplary embodiment of the resin coating layer is the same as the resin that covers the surface of the magnetic particle in the first exemplary embodiment of the resin coating layer, and preferable examples thereof as well are same.

In the second exemplary embodiment of the carrier of the invention, the relationship between the number average particle diameter of the nigrosine d₂ (μm) and the mean spacing of profile irregularities on the surface of the magnetic particle Sm satisfies preferably 0.25Sm (or about 0.25Sm)≦d₂≦2Sm (or about 2Sm). When the relationship is satisfied, the adherence between the magnetic particle and the resin coating layer is improved. Furthermore, even when the carbon black or nigrosine is trapped in a recess of the magnetic particle, the trapped carbon black or nigrosine uniformly covers the magnetic particle. As the result, even when the resin coating layer is worn after long term use, the magnetic particle is not exposed, and thus the adherence of the carrier to the photoreceptor caused by electric charges injected from a developer holder may be suppressed. Furthermore, nigrosine forms a structure where nigrosine particles are trapped in a recess of the magnetic particle, and next nigrosine particles are trapped thereon in a recess formed between already-trapped nigrosine particles (a structure such as a close-packed structure). Accordingly, nigrosine forms a most stable configuration and separation of nigrosine is inhibited.

The relationship between the number average particle diameter of the nigrosine d₂ (μm) and the mean spacing of profile irregularities on the surface of the magnetic particle Sm satisfies preferably 0.25Sm (or about 0.25Sm)≦d₂≦2Sm (or about 2Sm) and more preferably 0.25Sm (or about 0.25Sm)≦d₂≦1.2Sm (or about 1.2Sm). When d₂ exceeds 2Sm, the resin coating layer is easily worn, the charge amount of nigrosine exerts greater influence, and thereby the charge amount distribution of the toner tends to be broadened. On the other hand, when d₂ is less than 0.25Sm, nigrosine is not sufficiently trapped in a recess of the magnetic particle, and thus nigrosine separates off in some cases.

The number average particle diameter of the nigrosine is preferably from 0.1 μm (or about 0.1 μm) to 1 μm (or about 1 μm), more preferably from 0.1 μm (or about 0.1 μm) to 0.8 μm (or about 0.8 μm) and still more preferably from 0.1 μm (or about 0.1 μm) to 0.5 μm (or about 0.5 μm), from the viewpoint of improving the strength of the resin coating layer. The number average particle diameter of the nigrosine may be measured by the same method as the aforementioned method of measuring the number average particle diameter of the carbon black.

In the invention, the mean spacing Sm of profile irregularities on the surface of the magnetic particle is obtained as follows: Three dimensional measurement over 2 nm square in horizontal and vertical directions (in a XY-axis plane) is conducted on each of 1000 particles of the core material, using a ultra-deep color laser 3D profile microscope VK-9500 (trade name, produced by Keyence Corporation) under conditions of a lens magnification of 3000 times and a laser scanning pitch in a height direction (Z-axis direction) of 0.01 μm, so that Sm is obtained. Although Sm is expressed by mm unit based on the standard, μm is used as a unit in this microscope.

(Magnetic Particle)

The magnetic particle used in the first and the second exemplary embodiments of the carrier of the invention (hereinafter, in some cases, collectively referred to as “carrier of the invention”) is not particularly limited, and known magnetic particles for carrier may be used. Examples thereof include magnetic metals such as iron, steel, nickel and cobalt, alloys thereof with at least one selected from manganese, chromium, a rare earth element and the like, and magnetic oxides such as ferrite and magnetite.

The magnetic particle is formed by granulation and sintering. However, in a pre-treatment, the magnetic particle is preferably finely pulverized. The pulverizing method is not particularly limited, and may be in accordance with a known pulverizing method. Specific examples thereof include methods using a mortar, a ball mill or a jet mill.

The sintering temperature is preferably adjusted to a temperature that is lower than conventional sintering temperatures. Specifically, the sintering temperature may be varied in accordance with the material to be used, and is preferably from 500° C. to 1200° C. and more preferably from 600° C. to 1000° C. When the sintering temperature is lower than 500° C., a necessary magnetic force as a carrier may not be obtained. On the other hand, when the sintering temperature is higher than 1200° C., the crystal grows fast so that the internal structure easily becomes uneven, and so that cracks and flaws may be easily generated; further the mean spacing Sm of profile irregularities on the surface may be difficult to control and, thereby, the relationship with the particle diameter of carbon black or nigrosine may be outside a preferable range.

In order to adopt a low sintering temperature, the sintering step preferably includes stepwise pre-sintering steps. Accordingly, the time the entire sintering process takes is preferably longer.

The volume average particle diameter of the magnetic particles is preferably from 10 μm to 500 μm, more preferably from 30 μm to 150 μm and still more preferably from 30 μm to 100 μm. When the volume average particle diameter of the magnetic particles is less than 10 μm and the magnetic particles are used in an electrostatic charge image developer, the adhesive force between the toner and the carrier is high, so that the toner developing amount is reduced in some cases. On the other hand, when the volume average particle diameter exceeds 500 μm, the magnetic brush is coarse and thus fine images are difficult to form in some cases.

As the magnetic force, the saturation magnetization of the magnetic particles in a magnetic field of 3000 Oe is preferably 50 emu/g (or about 50 emu/g) or more and more preferably 60 emu/g (or about 60 emu/g) or more. When the saturation magnetization is smaller than 50 emu/g, the carrier together with a toner may be developed on a photoreceptor.

The device used to measure the magnetic properties is a vibration sample type magnetism-measuring device (trade name: VSMP 10-15 manufactured by Toei Industry Co., Ltd). A sample to be measured is filled in a cell having an inside diameter of 7 mm and a height of 5 mm, and then the cell is set into the device. In the measurement, a magnetic field is applied to the sample, and sweeping up to a maximum value of 3,000 Oe is performed. Next, the applied magnetic field is decreased to prepare a hysteresis curve oil a recording paper. From data indicated by the curve, saturation magnetization, residual magnetization, and coercivity are obtained. In the invention, saturation magnetization refers to a magnetization measured in a magnetic field of 3,000 Oe.

The volume resistance (volume resistivity) of the magnetic particles is in the range of preferably from 10⁵ Ω·cm (or about 10⁵ Ω·cm) to 10^{9.5} Ω·cm (or about 10^{9.5} Ω·cm) and more preferably in the range of from 10⁷ Ω·cm (or about 10⁷ Ω·cm) to 10⁹ Ω·cm (or about 10⁹ Ω·cm). When the volume resistance is less than 1×10⁵ Ω·cm and the toner concentration in the developer is decreased by repeated copying, electric charges may be injected to the carrier, and the carrier itself may be developed. On the other hand, when the volume resistance is larger than 1×10^{9.5} Ω·cm, detrimental effects on image quality, such as a remarkable edge effect and a false contour, may be is caused.

The volume resistance of the magnetic particles (Ω·cm) is measured as described below. The measurement environment is set to a temperature of 20° C. and a humidity of 50% RH.

On a surface of a circular jig to which an electrode plate of 20 cm² is provided, a sample to be measured is placed flat so as to form a layer having a thickness of approximately 1 to 3 mm. Thereon, an electrode plate of 20 cm² that is similar to the above electrode plate is placed to sandwich the layer. In order to remove a gap between pieces of the sample to be measured, a weight of 4 kg is applied onto the electrode plate placed on the layer, and the thickness (cm) of the layer is measured. Both electrodes above and below the layer are connected to an electrometer and a high voltage generator. A high voltage is applied to both electrodes so that an electric field becomes 10^{3.8} V/cm, the current value (A) flowing at that voltage is read, and the volume resistance (Ω·cm) of the sample is calculated. The Formula for calculating the volume resistance (Ω·cm) of the sample to be measured is as shown in a Formula (1) below.

R=E×20/(I−I₀)/L Formula (1)

In the Formula (1), R represents the volume resistance (Ω·cm) of the sample to be measured, E represents the applied voltage (V), I represents the current value (A), I₀ represents the current value (A) when the applied voltage is 0 V and L represents the thickness (cm) of the layer. A factor of 20 expresses an area (cm²) of the electrode plate.

The surface coverage of the resin coating layer on the magnetic particles (the proportion of the magnetic particle surface covered by the resin coating layer) is preferably 95% (or about 95%) or more, more preferably 98% (or about 98%) or more and most preferably 100% (or about 100%). When the surface coverage is less than 95%, electric charges may be injected to the carrier over long-term use, the charge-injected carrier may move onto the latent image holding member, so that a white spot may occur in an image.

The surface coverage of the resin coating layer can be obtained by XPS measurement (X-ray photoelectron spectrometry). As the XPS measurement apparatus, JPS80 (trade name, produced by JEOL Ltd.) is used. In the measurement, a Mg Kα ray is used as the X-ray source. The acceleration voltage is set to 10 kV and the emission current is set to 20 mV. Measurement is conducted on at least one main element that constitutes the coating layer (usually, carbon) and at least one main element that constitute the magnetic particles (iron and oxygen when the magnetic particles are iron oxide-based particles such as magnetite). Hereinafter, explanation is given assuming that the magnetic particles are iron oxide-based particles. Here, a C1s spectrum is measured for carbon, a Fe2p3/2 spectrum is measured for iron and O1s spectrum is measured for oxygen.

Based on the spectrum of each of the elements, the respective numbers of carbon atoms, oxygen atoms and iron atoms (A_{C}, A_{O}, and A_{Fe}) are obtained. From the obtained numbers of carbon atoms, oxygen atoms and iron atoms, an iron amount ratio of the magnetic particles alone and an iron amount ratio after the magnetic particle is covered with a coating layer (an iron amount ratio of carrier) are obtained based on a Formula (2) below, and a coverage is obtained based on a Formula (3) below.

Iron amount ratio (atomic %)=A_{Fe}/(A_{C}+A_{O}+A_{Fe})×100 Formula (2)

Coverage (%)={1−(iron amount ratio of carrier)/(iron amount ratio of magnetic particles alone)}×100 Formula (3)

When, as the magnetic particles, a material other than iron oxide series is used, a spectrum of at least one metal element constituting the magnetic particles other than oxygen is measured, and coverage may be obtained by calculations similar to the calculations based on the Formulas (2) and (3)

The average film thickness of the resin coating layer is preferably from 0.1 μm (or about 0.1 μm) to 10 μm (or about 10 μm), more preferably from 0.1 μm (or about 0.1 μm) to 3.0 μm (or about 3.0 μm) and still more preferably from 0.1 μm (or about 0.1 μm) to 1.0 μm (or about 1.0 μm). If the average film thickness of the coating layer is smaller than 0.1 μm, the electric resistance may be lowered by peeling of the coating layer during long-term use, and/or carrier breakage may not be controlled sufficiently. On the other hand, if the average film thickness is more than 10 μm, it may take much time for the charge amount to reach the saturation charge amount.

The average film thickness (μm) of the coating layer can be obtained by the following Formula (4), wherein ρ (dimensionless) represents the true specific gravity of the magnetic particles, d (μm) represents the volume-average particle diameter of the magnetic particles, ρc represents the average specific gravity of the coating layer, and Wc (parts by weight) represents the total amount of the coating layer per 1 part by weight of the magnetic particles:

$$\begin{matrix}Average film thickness ( μm ) = [ the amount of the \\ coating resin \\ ( including all additives , \\ for example \\ electroconductive powder ) \\ per one carrier particle / \\ the surface \\ area per one carrier particle ] / \\ ( the average specific gravity \\ of the coating layer ) \\ = [ 4 \text{/} 3 π \cdot {( d \text{/} 2 )}^{3} \cdot ρ \cdot Wc ] / \\ [ 4 π \cdot {( d / 2 )}^{2} ] / ρ c \\ = ( 1 / 6 ) \cdot ( d \cdot ρ \cdot Wc / ρ c )\end{matrix} \qquad Formula ( 4 )$$

(Various Physical Properties of Carrier)

The average particle diameter of the carrier is preferably from 15 μm to 50 μm, more preferably from 25 μm to 40 μm. If the average particle diameter of the carrier is less than 15 μm, contamination with the carrier may deteriorate. If the average particle diameter is more than 50 μm, the toner may be remarkably deteriorated by stirring.

The average particle diameter of the carrier is obtained by measuring the maximum particle diameter of each of individual particles from SEM (Scanning Electron Microscopy) photographs, followed by obtaining an average of the maximum particle diameters for 100 particles. Accordingly, the obtained average particle diameter is a number average particle diameter.

The shape factor SF1 of the carrier is preferably from 120 (or about 120) to 145 (or about 145), in order to obtain both of high image quality and cleanability.

The shape factor SF1 of the carrier refers to a value obtained by the following Formula (5):

SF1=100π×(ML)²/(4×A) Formula (5)

In Formula (5), ML represents the maximum length of a carrier particle and A represents the projected area of the carrier particle. The maximum length of a carrier particle and the projected area of the carrier particle are obtained by observing the carrier particle sampled on a slide glass with an optical microscope, taking all image thereof into an image analyzer (trade name: LUZEX III, manufactured by Nireco Co.) through a video camera, and then analyzing the image. The number of particles sampled at this time is 100 or more, and the average of the values for the particles calculated by Formula (5) is considered to be the shape factor.

The saturation magnetization of the carrier is preferably 40 emu/g (or about 40 emu/g) or more and more preferably 50 emu/g (or about 50 emu/g) or more.

The device used to measure the magnetic properties is a vibration sample type magnetism-measuring device (trade name: VSMP 10-15 manufactured by Toei Industry Co., Ltd). A sample to be measured is filled in a cell having an inside diameter of 7 mm and a height of 5 mm, and then the cell is set into the device. In the measurement, a magnetic field is applied to the sample, and sweeping up to a maximum value of 1,000 Oe is performed. Next, the applied magnetic field is decreased to prepare a hysteresis curve on a recording paper. From data indicated by the curve, saturation magnetization, residual magnetization, and coercivity are obtained. In the invention, the saturation magnetization refers to a value measured in a magnetic field of 1,000 Oe.

The volume resistance (at 25° C.) of the carrier is controlled preferably in the range of from 1×10⁷Ω·cm (or about 1×10⁷ Ω·cm) to 1×10¹⁵ Ω·cm (or about 1×10¹⁵ Ω·cm), more preferably in the range of from 1×10⁸ Ω·cm (or about 1×10⁸ Ω·cm) to 1×10¹⁴ Ω·cm (or about 1×10¹⁴ Ω·cm) and still more preferably in the range of from 1×10⁸ Ω·cm (or about 1×10⁸ Ω·cm) to 1×10¹³ Ω·cm (or about 1×10¹³ Ω·cm).

When the volume resistance of the carrier is greater than 1×10¹⁵ Ω·cm (or greater than about 1×10¹⁵ Ω·cm), because of high resistance, it is difficult for the carrier to work as a development electrode at the time of development; accordingly, in some cases, deterioration of the solid reproducibility such as occurrence of an edge effect, in particular in a solid image portion, may be caused. On the other hand, when the volume resistance is less than 1×10⁷ Ω·cm (or less than about 1×10⁷ Ω·cm), in some cases, lowered electric resistance may easily cause troubles such as development of the carrier itself due to injection of charges from a developing roll to the carrier when the toner concentration in a developer is lowered.

The volume electric resistivity of the carrier is measured similarly to the measurement of the volume electric resistivity of the magnetic particle.

(Electrostatic Charge Image Developer)

The electrostatic charge image developer of the invention, which may be simply referred to as “developer” hereinafter, includes at least a toner and a carrier wherein the carrier is the aforementioned carrier according to an exemplary embodiment of the invention.

The toner is not particularly limited, and may be any known toner. A typical example of the toner is colored toner comprising a binder resin and a colorant. An infrared absorbing toner, wherein an infrared absorbent is used instead of the colorant, may be used. Besides these components, a release agent, various internal additives and external additives, and other components may be added thereto, as necessary.

In the next place, the toner used in the developer of the invention will be detailed. Examples the binder resin contained in the toner include homopolymers or copolymers of: monoolefins such as ethylene, propylene, butylene and isoprene; vinyl esters such as vinyl acetate, vinyl propionate, vinyl benzoate, and vinyl lactate; α-methylene aliphatic monocarboxylic acid esters such as methyl acrylate, phenyl acrylate, octyl acrylate, methyl methacrylate, ethyl methacrylate, butyl methacrylate and dodecyl methacrylate; vinyl ethers such as vinyl methyl ether, vinyl ethyl ether, and vinyl butyl ether; and vinyl ketones such as vinyl methyl ketone, vinyl hexyl ketone, vinyl isopropenyl ketone.

Among these, examples of particularly representative binder resins include polystyrene, a styrene-alkyl acrylate copolymer, a styrene-butadiene copolymer, a styrene-maleic anhydride copolymer, polystyrene and polypropylene. Furthermore, polyester, polyurethane, an epoxy resin, a silicone resin, polyamide and modified rosin may be also mentioned.

The colorant is not particularly limited, and examples thereof include carbon black, aniline blue, chalcoyl blue, chromium yellow, ultramarine blue, Dupont oil red, quinoline yellow, methylene blue chloride, phthalocyanine blue, malachite green oxalate, lamp black, rose bengal, C.I. Pigment Red 48:1, C.I. Pigment Red 122, C.I. Pigment Red 57:1, C.I. Pigment Yellow 97, C.I. Pigment Yellow 12, C.I. Pigment Blue 15:1, and C.I. Pigment Blue 15:3.

If necessary, the toner may contain a charge controller. When used in a color toner, the charge controller is preferably a colorless or light-colored charge controller which does not affect the color tone of an image. The charge controller may be a known charge controller. It is preferable to use an azo metal complex, a metal complex or metal salt of salicylic acid or an alkyl salicylate, or the like.

Furthermore, if necessary, the toner may contain a release agent in order to prevent offset or the like.

Examples of the release agent include: paraffin wax and derivatives thereof, montan wax and derivatives thereof; microcrystalline wax and derivatives thereof, Fischer Tropsch wax and derivatives thereof; and polyolefin wax and derivatives thereof. Examples of the derivatives include: oxides thereof; polymers thereof further containing a vinyl monomer; and graft modified products thereof. Besides, the following may be used: an alcohol, an aliphatic acid, a plant wax, an animal wax, a mineral wax, an ester wax, an acid amide, or the like.

Inorganic oxide particles may be added to the inside of the toner Examples of the inorganic oxide particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄ particles. Of these examples, silica and titania particles are preferable in particular. The surface of the oxide particles may be subjected to hydrophobizing treatment in advance, though the hydrophobizing treatment is not essential. When the surface is subjected to hydrophobizing treatment, the variation of the charging of the toner in various environments and contamination with the carrier may be effectively decreased even if the inorganic particles inside the toner are partially exposed on the toner surface.

The hydrophobizing treatment may be conducted by immersing the inorganic oxide in a hydrophobizing treatment agent. The hydrophobizing treatment agent is not particularly limited, and examples thereof include silane coupling agents, silicone oil, titanate coupling agents, and aluminum coupling agents. Only a single hydrophobizing treatment agent may be used, or two or more hydrophobizing treatment agents may be used simultaneously. Of these examples, silane coupling agents are preferable.

The silane coupling agent may be of any one of chlorosilane, alkoxysilane, silazane, and special silylating agent types. Specific examples thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltriethoxysilane, decyltrimethoxysilane, hexamethyldisilazane, N,O-(bistrimethylsilyl)acetamide, N,N-(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethoxysilane, and γ-chloropropyltrimethoxysilane.

The amount of the hydrophobizing treatment agent cannot be specified generally since the amount is varied in accordance with the kind of the inorganic oxide particles, and other factors. Usually, the amount is preferably about from about 5 to about 50 parts by weight with respect to 100 parts by weight of the inorganic oxide particles.

Inorganic oxide particles may be added to the surface of the toner. Examples of the inorganic oxide particles added to the toner surface include particles of any of the following: SiO₂, TiO₂, Al₂O₃, CuO, ZnO, SnO₂, CeO₂, Fe₂O₃, MgO, BaO, CaO, K₂O, Na₂O, ZrO₂, CaO.SiO₂ K₂O.(TiO₂)ₙ, Al₂O₃.2SiO₂, CaCO₃, MgCO₃, BaSO₄, and MgSO₄. Of these examples, silica particles and titania particles are preferable. The surface of the oxide particles has preferably been subjected to hydrophobizing treatment in advance. This hydrophobizing treatment makes it possible to improve the powder fluidity of the toner and effectively decrease the variation of the charging in various environments and contamination with the carrier.

The hydrophobizing treatment may be conducted, similarly to the above, by immersing the inorganic oxide in a hydrophobizing treatment agent. The hydrophobizing treatment agent is not particularly limited, and examples thereof include silane coupling agents, silicone oil, titanate coupling agents, and aluminum coupling agents. Only a single hydrophobizing treatment agent may be used, or two or more hydrophobizing treatment agents may be used simultaneously. Of these examples, silane coupling agents are preferable.

The silane coupling agent may be of any one of chlorosilane, alkoxysilane, silazane, and special silylating agent types. Specific examples thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltriethoxysilane, decyltrimethoxysilane, hexamethyldisilazane, N,O-(bistrimethylsilyl)acetamide, N,N-(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethoxysilane, and γ-chloropropyltrimethoxysilane.

The amount of the hydrophobizing treatment agent is, similarly to the above, cannot be specified generally since the amount is varied in accordance with the kind of the inorganic oxide particles, and other factors. Usually, the amount is preferably from about 5 to about 50 parts by weight with respect to 100 parts by weight of the inorganic oxide particles.

Regarding the particle size distribution of the toner, the proportion of the number of toner particles having a particle diameter of 4 μm or less to the total number of toner particles is preferably from 6 to 25% and more preferably from 6 to 16%. When the proportion of the toner particles having a particle diameter of 4 μm or less is 6% or less by number, particles contributing to fine dot reproducibility and granularity are scarce and the toner particles having a particle diameter of 4 μm or less are selectively consumed because toner particles with such a particle size are effective for such properties. Accordingly, when a copying process is repeated, toner particles having particle diameters that make less contribution to development are retained in the developing unit, which may cause deterioration in image quality. On the other hand, when the proportion of toner particles having a particle diameter of 4 μm or less exceeds 25% by number, there is a possibility that the transportability of the developer may be lowered due to decreased fluidity of the toner, and the developability may be adversely affected.

The content of toner particles having a particle diameter of 16 μm or more is preferably 1.0% by volume (or about 1.0% by volume) or less with respect to the total amount of toner particles. If the content is larger than 1.0% by volume, the reproducibility of fine lines and the gradation of images may be adversely affected, and the presence of coarse toner particles having a particle diameter of 16 μm or more in the toner layer at the time of transfer may inhibit electrostatic adhesion between the electrostatic latent holding member and the transfer receiver, and may lower the efficiency of transfer and image quality.

The volume-average particle diameter of the toner is preferably from 5 to 9 μm. In order to reproduce a high image quality, it is preferable that this range and the above-mentioned preferable range of the particle diameter distribution are both satisfied. If the volume-average particle diameter is less than 5 μm, the fluidity of the toner lowers, and fogging may be generated in a background portion or the reproducibility of image density may be lowered since sufficient charge may be less likely to be imparted to the toner by the carrier. If the volume-average particle diameter is more than 9 μm, the above-mentioned characteristics of the carrier may not be sufficiently exhibited, and the effects of improving the reproducibility of fine dots, the graduation and the granularity may be reduced.

Accordingly, when the toner has the above-mentioned toner particle diameter distribution and volume-average particle diameter, a high reproducibility may be expected with respect to fines dots of electrostatic latent images even in repeated copying of a manuscript having a large image area and a gradation in density, such as a photograph or a pamphlet.

The particle size distribution and the volume average particle diameter of the toner are measured with COULTER MULTI-SIZER II (trade name, produced by Beckmann-Coulter Incorporation), and ISOTON-II (trade name, produced by Beckmann-Coulter Incorporation) as an electrolytic solution. Based on the counts for the respective divided particle size ranges (channels) obtained from the measured particle size distribution, a cumulative volume distribution curve is drawn from the smaller particle size side in place of drawing a cumulative weight distribution from the small size side, and a particle size at which the cumulative volume becomes 50% of the total volume is defined as the volume average particle diameter.

The method for producing the toner may be a commonly used method, such as a kneading pulverization method or a wet granulation method. Examples of the wet granulation method include a suspension polymerization method, an emulsion polymerization method, an emulsion polymerization aggregation method, a soap-free emulsion polymerization method, a non-aqueous dispersion polymerization method, an in-situ polymerization method, an interfacial polymerization method, an emulsifying dispersion granulation method, and an aggregation-coalescence method.

In order to produce a toner by the kneading pulverization method, a binder resin, an optional colorant, and other optional additives are sufficiently mixed with a mixer such as a Henschel mixer or a ball mill. The mixture is melted and kneaded with a thermal kneader such as a heating roll, a kneader or an extruder, so as to make the resin and the other components compatible with each other. In the resultant mixture, an infrared absorbent, an antioxidant and others are dispersed or dissolved, and the obtained mixture is cooled and solidified, and then pulverized and classified to yield a toner.

In the case of forming toner particles by the wet granulation method, the shape factor of the toner particles is preferably in the range of 110 to 135.

The shape factor of the toner particles can be obtained in the same manner as that for obtaining the shape factor SF1 of the carrier.

About the blend ratio by weight between the toner and the carrier in the developer of the invention, the ratio by weight of the toner to the carrier is preferably in the range of from 0.01 to 0.3, more preferably from in the range of from 0.03 to 0.2.

The developer of the invention may be used as a developer which is put in a toner image forming unit (developer container) in advance, or as a replenishing developer used in a developing method where a carrier is added together with a toner that is consumed by development to replace the carrier in a developing unit little by little so as to suppress a variation in the charge amount, and so as to stabilize image density (a trickle developing method).

Regarding the blend ratio by weight between the toner and the carrier in the case of using the developer of the invention as the replenishing developer used in the trickle developing method or the like, the ratio by weight of the toner to the carrier is preferably 2 or more, more preferably 3 or more, and even more preferably 5 or more.

(Image Forming Method)

An image forming method of the invention includes: charging a surface of a latent image holding member; forming an electrostatic latent image on the charged surface of the latent image holding member; developing the electrostatic latent image formed on the surface of the latent image holding member as a toner image using a developer containing a toner; transferring the toner image from the surface of the latent image holding member to a recording medium; and fixing the toner image that has been transferred onto the recording medium, and the electrostatic charge image developer of the invention is used as the developer.

In addition, besides the above steps, the image forming method may further include a known step as necessary, such as a cleaning step for cleaning the surface of the latent image holding member. Furthermore, the transferring may be conducted by an intermediate transfer method where a toner image is transferred from the latent image holding member through an intermediate transfer body to a recording medium.

Furthermore, in the image forming method of the invention, the ratio of the velocity of the surface of the latent image holding member to the velocity of a surface of a developer holder during development (a rotation speed of the surface of the latent image holding member: a rotation speed of a surface of a developer holder) is preferably from 1:1.5 (or about 1:1.5) to 1:5 (or about 1:5).

(Electrostatic Charge Image Developer Cartridge, Image forming Apparatus and Process Cartridge)

Furthermore, the developer of the invention may be used in known electrostatic charge image developer cartridges, image forming apparatuses and process cartridges. Thereby, sensitivity to variations in environment and the occurrence of colored spots and fixing defects may be suppressed over long-term use.

An electrostatic charge image developer cartridge of the invention (hereinafter; in some cases, simply referred to as a “cartridge”) is attachable to and detachable from an image forming apparatus, the image forming apparatus including at least: a latent image holding member; a developing unit that develops an electrostatic latent image formed on a surface of the latent image holding member as a toner image using a developer containing a toner; and a transferring unit that transfers the toner image from the surface of a latent image holding member to a recording medium. The cartridge accommodates a developer that is to be supplied to the developing unit, and the developer is the developer of the invention.

The cartridge of the invention may be a cartridge that accommodates the developer of the invention. Alternatively, a cartridge that accommodates a toner alone and a cartridge that accommodates the carrier of the invention alone may be separately provided.

An image forming apparatus of the invention includes at least: a latent image holding member; a developing unit that develops an electrostatic latent image formed on a surface of a latent image holding member as a toner image using a developer containing a toner; a transferring unit that transfers the toner image from the surface of the latent image holding member to a recording medium; and a fixing unit that fixes the toner image that has been transferred onto the recording medium, and the electrostatic charge image developer of the invention is used as the developer.

Furthermore, the ratio of the velocity of the surface of the latent image holding member to the velocity of the surface of a developer holder in the developing unit (a rotation speed of the surface of the latent image holding member: a rotation speed of the surface a developer holder) is preferably from 1:1.5 (or about 1:1.5) to 1:5 (or about 1:5).

The image forming apparatus of the invention may include at least the latent image holding member, the charging unit, the electrostatic latent image forming unit, the toner image forming unit, the transferring unit and the fixing unit. If necessary, the image forming apparatus of the invention may further include a cleaning unit in which a cleaning blade may be used for example, and/or a neutralizing unit.

Furthermore, the toner image forming unit may have a configuration that includes a developer container that accommodates a developer, a developer supplying unit that supplies a replenishing developer to the developer container and a developer discharging unit that discharges at least a part of the developer accommodated in the developer container, that is, a configuration of a trickle developing system.

In this case, when the developer of the invention is used as a replenishing developer, sensitivity to variations in the environment and the occurrence of color points and fixing defects may be suppressed over long-term use.

Regarding a toner/carrier mixing weight ratio of the developer (replenishing developer) to be supplied to the developer container, a ratio range, toner weight/carrier weight ≧2, is preferable, and a ratio range, toner weight/carrier weight ≧3, is more preferable and a ratio range, toner weight/carrier weight ≧5, is still more preferable.

A process cartridge of the invention is attachable to and detachable from an image forming apparatus, and the process cartridge includes at least a latent image holding member and a developing unit that develops an electrostatic latent image formed on a surface of the latent image holding member as a toner image using a developer containing a toner. The developer is the aforementioned developer of the invention.

The process cartridge may include at least one selected from a charging unit, a cleaning unit and a neutralizing unit in accordance with the necessity.

The developing unit in the image forming apparatus or the process cartridge usually has at least a developer holder that supplies a developer onto a surface of an latent image holding member, and the developer holder may be a cylindrical member that supplies the developer onto the surface of the latent image holding member while rotating.

Herein, the peripheral speed of the developer holder is preferably at least 400 ml-n/s (or at least about 400 mm/s) and more preferably at least 450 mm/s (or at least about 450 mm/s) when the developer is supplied. High-speed image formation may be realized with an image forming apparatus or with an image forming apparatus to which a process cartridge is attached, in a high-speed range at which the peripheral speed of the developer holder is 400 mm/s or more; however; at the same time, large mechanical stress is exerted on the developer during image formation, and the coating layer material in the coating layer may peel easily.

However, when the developer of the invention is used as the developer used in the image forming apparatus or in the process cartridge, even when high-speed image formation is performed over a long term, sensitivity to variations in the environment is low and, similarly to the case of a peripheral speed of the developer holder of less than 400 mm/s, the color points and fixing defects may be easily suppressed.

The upper limit of the peripheral speed of the developer holder is not particularly limited, and the limit is preferably 1500 mm/s or less and more preferably 1200 mm/s or less from the practical viewpoint.

In what follows, specific examples of the image forming apparatus and the process cartridge of the invention will be specifically described with reference to the drawings.

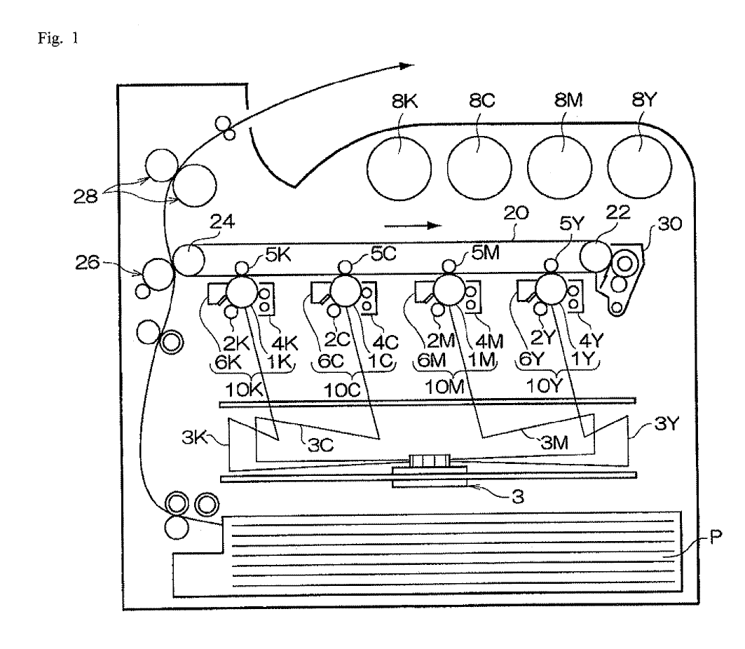

FIG. 1 is a schematic configurational diagram showing an example of the image forming apparatus of the invention (a quadruple tandem type full-color image forming apparatus). The image forming apparatus shown in FIG. 1 includes first to fourth electrophotographic image forming units 10Y, 10M, 10C and 10K (image forming units) of an electrophotographic method that outputs images of the respective colors of yellow (Y), magenta (M), cyan (C) and black (K) based on color-separated image data. The image forming units (hereinafter, simply referred to as “units”) 10Y, 10M, 10C and 10K are disposed in parallel in a horizontal direction at a predetermined distance from each other. The units 10Y, 10M, 10C and 10K may be process cartridges that are attachable to and detachable from the image forming apparatus main body.

In an upper side in the drawing of the respective units 10Y, 10M, 10C and 10K, an intermediate transfer belt 20 as an intermediate transfer body is disposed to extend through the respective units. The intermediate transfer belt 20 is wound around a driving roller 22 and a support roller 24 which is in contact with the inner surface of the intermediate transfer belt 20. The driving roller 22 and the support roller 24 are disposed from right to left in the drawing, and are separated from each other. The intermediate transfer belt 20 runs in the direction of from the first unit 10Y to the fourth unit 10K. The support roller 24 is pressed in the direction departing from the driving roller 22 by a spring or the like (not shown in the drawing) to provide a certain tension to the intermediate transfer belt 20 wound around the both rollers. On the image holding member side surface of the intermediate transfer belt 20, an intermediate transfer body cleaning unit 30 is disposed to oppose the driving roller 22.

Furthermore, toners of four colors of yellow, magenta, cyan and black, which are stored in toner cartridges 8Y, 8M, 8C and 8K respectively, may be supplied to developing units (developing parts) 4Y, 4M, 4C and 4K of the respective units 10Y, 10M, 10C and 10K.

The aforementioned first to fourth units 10Y, 10M, 10C and 10K have equivalent configurations. Accordingly, the first unit 10Y that forms a yellow image, which is disposed on the upstream side in the running direction of the intermediate transfer belt, will be described as a representative thereof. In portions equivalent to that of the first unit 10Y, reference marks provided with magenta (M), cyan (C) and black (K) are imparted in place of yellow (Y), and descriptions of the second to fourth units 10M, 10C and 10K are omitted.

The first unit 10Y has a photoreceptor 1Y that works as an latent image holding member. Around the photoreceptor 1Y, a charging roller 2Y that charges a surface of the photoreceptor 1Y to a predetermined potential; an exposure unit 3 that exposes the charged surface by a laser ray beam 3Y based on color-separated image signals to form an electrostatic charge image; a developing unit (developing part) 4Y that supplies a charged toner to the electrostatic charge image to develop the electrostatic charge image; a primary transfer roller 5Y (primary transfer part) that transfers the developed toner image onto the intermediate transfer belt 20; and a photoreceptor cleaning unit (cleaning part) 6Y that removes toner remaining on the surface of the photoreceptor 1Y after the primary transfer, are sequentially disposed.

The primary transfer roller 5Y is disposed at the inner side of the intermediate transfer belt 20 at a position that opposes the photoreceptor 1Y. Furthermore, bias power sources (not shown in the drawing) that apply primary transfer biases are connected to the respective primary transfer rollers 5Y, 5M, 5C and 5K. Each bias power source changes the transfer bias applied to the corresponding primary transfer roller by a controller (not shown).

In what follows, an operation by which a yellow image is formed in the first unit 10Y will be described. Prior to the operation, a surface of a photoreceptor 1Y is charged to a potential of approximately −600 V to −800 V by a charging roller 2Y.

The photoreceptor 1Y is formed by laminating a photosensitive layer on a conductive base material (having a volume resistance at 20° C. of 1×10⁻⁶ Ω·cm or less). The photosensitive layer is usually in a high resistance state (comparable to the resistance of a usual resin), but has a property of changing the specific resistance of a portion irradiated with a laser beam (laser beam 3Y). The laser beam 3Y is output through an exposing unit 3 onto the charged surface of the photoreceptor 1Y, in accordance with yellow image data transmitted from a controller (not shown). The laser beam 3Y is irradiated on the photosensitive layer on the surface of the photoreceptor 1Y, whereby an electrostatic charge image of a yellow printing pattern is formed on the surface of the photoreceptor 1Y.

The electrostatic charge image is an image formed by charging on the surface of the photoreceptor 1Y and is a so-called negative latent image formed by the following manner: the specific resistance of the irradiated portion of the photosensitive layer is lowered by the laser beam 3Y to allow electric charges on the surface of the photoreceptor 1Y to flow out, while electric charges of a portion that is not irradiated by the laser beam 3Y remain.

The electrostatic charge image formed thus on the photoreceptor 1Y is conveyed to a predetermined developing position owing to the rotation of the photoreceptor 1Y Then, the electrostatic charge image on the photoreceptor 1Y is visualized (developed) by a developing unit 4Y at the developing position.

For example, a yellow toner that contains at least a yellow coloring agent, a crystalline resin and an amorphous resin and has a volume average particle diameter of 7 μm is stored in the developing unit 4Y. The yellow toner is turbocharged by being agitated inside of the developing unit 4Y, and the yellow toner having an electric charge of the same polarity (negative polarity) as that of electric charges provided by charging on the photoreceptor 1Y is retained on a developer roll (developer holder). Then, when the surface of the photoreceptor 1Y goes past the developing unit 4Y, the yellow toner is electrostatically adhered to a neutralized latent image portion on a surface of the photoreceptor 1Y and develops the latent image. The photoreceptor 1Y on which the yellow toner image is formed is run at a predetermined speed and thereby the developed toner image on the photoreceptor 1Y is conveyed to a predetermined primary transfer position.

When the yellow toner image on the photoreceptor 1Y is conveyed to the primary transfer position, a predetermined primary transfer bias is applied to a primary transfer roller 5Y and thereby an electrostatic force directing from the photoreceptor 1Y to the primary transfer roller 5Y works on the toner image and the toner image on the photoreceptor 1Y is transferred onto an intermediate transfer belt 20. The transfer bias applied at this time is of (+) polarity, which is opposite to the polarity (−) of the toner. For example, the transfer bias of the first unit 10Y is controlled to approximately +10 μA by a controller (not shown in the drawing).

On the other hand, the residual toner remaining on the photoreceptor 1Y is removed and recovered by a cleaning unit 6Y.

Furthermore, primary transfer biases applied to the primary transfer rollers 5M, 5C and 5K located downstream the first unit 10Y as well are controlled similarly to the first unit.

Thus, an intermediate transfer belt 20 on which the yellow toner image was transferred in the first unit 10Y is conveyed sequentially through the second to fourth units 10M, 10C and 10K, and thereby toner images of the respective colors are transferred and superposed to achieve multiple transfer.

The intermediate transfer belt 20 on which toner images of four colors are multiple-transferred through the first to fourth units reaches a secondary transfer portion that is constituted of the intermediate transfer belt 20, a support roller 24 in contact with the inner surface of the intermediate transfer belt 20 and a secondary transfer roller (secondary transfer unit) 26 disposed at the image holding surface side of the intermediate transfer belt 20. On the other hand, a recording paper (recording media) P is fed at a predetermined timing through a feeding unit to a gap between the secondary transfer roller 26 and the intermediate transfer belt 20 which are in pressure contact, and a predetermined secondary transfer bias is applied to the support roller 24. The transfer bias applied at this time has a (−) polarity, which is the same polarity as the polarity (−) of the toner, and thereby an electrostatic force directing from the intermediate transfer belt 20 to the recording paper P is exerted on the toner image to transfer the toner image on the intermediate transfer belt 20 onto the recording paper P. The secondary transfer bias at this time is determined depending on the resistance detected by a resistance detecting unit (not shown in the drawing) that detects the resistance of the secondary transfer portion, and is controlled by a voltage.

The color-superposed toner image is melted and fixed on the recording paper P when the recording paper P is delivered to a fixing unit (fixing part) 28 to heat the toner image. The recording paper P where a color image has been fixed is conveyed to an exit portion and thereby a series of color image forming operations comes to completion.

In the exemplified image forming apparatus, the toner image is transferred onto the recording paper P through the intermediate transfer belt 20. However, the image forming apparatus is not limited to this configuration, and may have a structure in which a toner image is directly transferred from the photoreceptor to the recording paper.

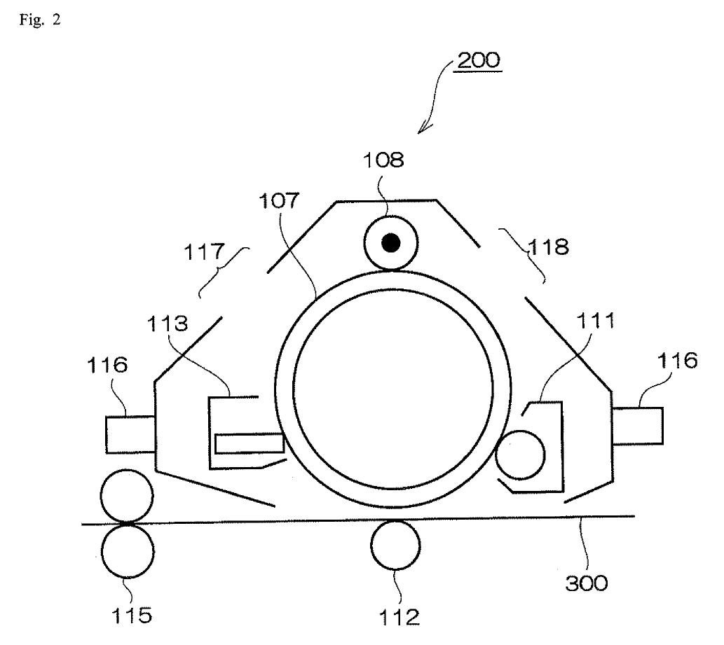

FIG. 2 is a schematic configurational diagram showing one example of a process cartridge that stores an electrostatic charge image developer of the invention. A process cartridge 200 is formed by combining and integrating, by using an attaching rail 116, a photoreceptor (latent image holding member) 107, a charging roller (charging unit) 108, a developing unit (developing part) 111, a photoreceptor cleaning unit (cleaning part) 113, an opening 118 for exposure and an opening 117 for neutralizing exposure.

The process cartridge 200 is configured to be attachable to and detachable from an image forming apparatus main body that includes a transfer unit (transfer part) 112, a fixing unit (fixing part) 115 and other constituent portion(s) (not shown), and constitutes an image forming apparatus together with the image forming apparatus main body. Reference numeral 300 represents recording paper.

The process cartridge shown in FIG. 2 includes a charging unit 108, a developing unit 111, a cleaning unit (cleaning part) 113, an opening 118 for exposure and an opening 117 for discharging exposure. However, these units may be selectively combined. The process cartridge of the invention includes, besides the photoreceptor 107, at least one selected from the group consisting of a charging unit 108, a developing unit 111, a cleaning unit (cleaning part) 113, an opening 118 for exposure and an opening 117 for neutralizing exposure.

### EXAMPLES

In what follows, the present invention will be described in more detail with reference to examples. However, the invention is not limited to the examples shown below. In the following description, “parts” and “%”, respectively, mean “parts by weight” and “% by weight”, unless indicated otherwise.

(Preparation of Carbon Black 1)

100 parts of abietic acid (produced by Harima Kasei Co., Ltd) is added to 200 parts of a 1 mol/L aqueous solution of sodium hydroxide. This is put in a ball mill, zirconia beads having a diameter of 1 mm is added thereto, and the content in the ball mill was rotated for 1 hrs. Naturally, the rotation number of the ball mill may be a rotation number at which the zirconia beads in the ball mill fall adequately in the ball mill. Thereafter, 100 parts of carbon black (trade name: RAVEN 890, produced by Colombian Chemicals Company) is added, followed by rotating further for 10 hrs. After the resultant mixture is taken out of the ball mill, sulfuric acid of 0.2 mol/L is added under agitation until the pH becomes 7.5 or less. Incidentally, the pH of the matter taken out of the ball mill before the addition of sulfuric acid is 13. This is sufficiently washed with water, followed by adding 10 parts of ethanol, further followed by adding 200 parts of methyl ethyl ketone, whereby carbon black 1 is prepared.

(Preparation of Carbon Black 2)

Carbon black 2 is prepared in the same way as the preparation of carbon black 1 except that the usage amount of abietic acid is changed from 100 parts to 70 parts.

(Preparation of Carbon Black 3)

Carbon black 3 is prepared in the same way as the preparation of carbon black 1 except that the usage amount of abietic acid is changed from 100 parts to 50 parts.

(Preparation of Carbon Black 4)

Carbon black 4 is prepared in the same way as the preparation of carbon black 1 except that the usage amount of abietic acid is changed from 100 parts to 20 parts.

(Preparation of Carbon Black 5)

Carbon black 5 is prepared in the same way as the preparation of carbon black 1 except that the usage amount of abietic acid is changed from 100 parts to 10 parts.

(Preparation of Carbon Black 6)

Carbon black 6 is prepared in the same way as the preparation of carbon black 1 except that abietic acid is changed to pimaric acid (produced by Harima Kasei Co., Ltd.).

(Preparation of Carbon Black 7)

Carbon black 7 is prepared in the same way as the preparation of carbon black 1 except that abietic acid is changed to neoabietic acid (produced by Harima Kasei Co., Ltd.).

(Preparation of Carbon Black 8)

Into 200 parts of methyl ethyl ketone, carbon black (trade name: RAVEN 890, produced by Colombian Chemicals Company, the same carbon black as that used in the preparation of carbon black 1) is added directly, and agitated together with zirconia beads, whereby carbon black 8 is prepared.

(Preparation of Nigrosine 1)

100 parts of abietic acid (produced by Harima Kasei Co., Ltd) is added to 100 parts of a 1 mol/L aqueous solution of sodium hydroxide. This is put in a ball mill and zirconia beads having a diameter of 1 mm are added. The content in the ball mill is rotated for 1 hr. Thereafter, 100 parts of nigrosine (produced by Orient Chemical Industries, Ltd.) is added, followed by rotating further for 10 hrs. After the resultant mixture is taken out of the ball mill, sulfuric acid of 0.2 mol/L is added under agitation until the pH becomes 7.5 or less. Incidentally, the pH of the matter taken out of the ball mill before the addition of sulfuric acid is 13. Then, water content is distilled away therefrom with an evaporator and 10 parts of ethanol is added, and then 200 parts of methyl ethyl ketone is added, whereby nigrosine 1 is prepared.

(Preparation of Nigrosine 2)

Nigrosine 2 is prepared in the same way as the preparation of nigrosine 1 except that the usage amount of abietic acid is changed from 100 parts to 70 parts.

(Preparation of Nigrosine 3)

Nigrosine 3 is prepared in the same way as the preparation of nigrosine 1 except that the usage amount of abietic acid is changed from 100 parts to 50 parts.

(Preparation of Nigrosine 4)

Nigrosine 4 is prepared in the same way as the preparation of nigrosine 1 except that the usage amount of abietic acid is changed from 100 palls to 20 parts.

(Preparation of Nigrosine 5)

Nigrosine 5 is prepared in the same way as the preparation of nigrosine 1 except that the usage amount of abietic acid is changed from 100 parts to 10 parts.

(Preparation of Nigrosine 6)

Nigrosine 6 is prepared in the same way as the preparation of nigrosine 1 except that abietic acid is changed to pimaric acid (produced by Harima Kasei Co., Ltd.).

(Preparation of Nigrosine 7)

Nigrosine 7 is prepared in the same way as the preparation of nigrosine 1 except that abietic acid is changed to neoabietic acid (produced by Harima Kasei Co., Ltd.).

(Preparation of Nigrosine 8)

Nigrosine (produced by Orient Chemical Industries Ltd.; the same nigrosine as that used in the preparation of nigrosine 1) is added directly to 200 parts of methyl ethyl ketone, and agitated together with zirconia beads, whereby nigrosine 8 is prepared.

(Preparation of Coating Agent 1)

| | |
|---|---|
| Polycyclohexyl methacrylate resin | 100 parts |
| (produced by Soken Chemical &Engineering Co., | |
| Ltd., weight average molecular weight: 65000): | |
| Toluene (produced by Wako Pure Chemical Industries Ltd.,): | 500 parts |
| Carbon black 1: | 0.24 parts |

The above components and zirconia beads (bead diameter: 1 mm, in the same amount as that of toluene) are put in a sand mill (produced by Kansai Paint Co., Ltd.), and agitated at a rotation speed of 1200 rpm for 30 min, whereby a coating agent 1 having a solid content of 18% is prepared.

(Preparation of Coating Agents 2 to 16)

Coating agents 2 to 8 are prepared in the same way as the preparation of coating agent 1 except that the carbon black 1 is changed respectively to the carbon blacks 2 to 8.

Coating agents 9 to 16 are prepared in the same way as the preparation of coating agent 1 except that the carbon black 1 is changed respectively to the nigrosines 1 to 8.

(Preparation of Coating Agents 17 and 18)

Coating agent 17 is prepared in the same way as the preparations of coating agent 1 except that the polycyclohexyl methacrylate resin is changed to a polymethyl methacrylate resin (weight average molecular weight: 75,000, produced by Soken Chemical & Engineering Co., Ltd.). Coating agent 18 is prepared in the same way as the preparations of coating agent 9 except that the polycyclohexyl methacrylate resin is changed to a polymethyl methacrylate resin (weight average molecular weight: 75,000, produced by Soken Chemical & Engineering Co., Ltd.).

(Preparation of Carrier 1)

2000 parts of DFC350 (trade name, produced by Dowa Kogyo K. K., Mn—Mg ferrite) and 320 parts of the coating agent 1 are put in a vacuum deaerating 5 L kneader, and the system is depressurized to −200 mmHg at 60° C. under agitation, followed by mixing for 20 min. Then, the temperature is increased and the pressure is decreased to 90° C. and −720 mmHg, and the particles are dried at the same temperature and pressure for 30 min, whereby coated particles are obtained. Furthermore, the coated particles are sieved by using a 75μ mesh, so that carrier 1 is prepared. The mean spacing Sm of profile irregularities on the surface of DFC350 is 0.4 μm.

(Preparation of Carriers 2 to 18)

Carriers 2 to 18 are prepared in the same way as the preparation of carrier 1 except that the coating agent 1 is changed to the coating agents 2 to 18 respectively.

The number average particle diameter of carbon black or nigrosine in a resin coating layer is measured by observing a resin coating layer portion of a section of a carrier with TEM. Specifically, the longest diameter of one particle of carbon black or nigrosine in a TEM photograph of a resin coating layer portion is measured, and the longest diameter is obtained for each of 100 particles. The obtained longest diameters are averaged, so that a number average particle diameter is obtained. In the measurement, an aggregate as well is calculated as one particle, and particles that are connected to each other on the photograph are considered to be one particle. The results are shown in Table 1.

(Preparation of Toner 1)

### (Preparation of Coloring Agent Dispersion Liquid 1)

| | |
|---|---|
| Cyan pigment: copper phthalocyanine B15: 3 | 50 parts |
| (produced by Dainichiseika Color & | |
| Chemicals Mfg. Co., Ltd.): | |
| Anionic surfactant: NEOGEN SC (trade name, | 5 parts |
| produced by Dai-ichi Kogyo Seiyaku Co., Ltd.): | |
| Ion exchange water: | 200 parts |

The above components are mixed, and then dispersed for 5 min with ULTRA-TURRAX (trade name, produced by IKA Corporation), and then dispersed for 10 min with an ultrasonic bath, whereby a coloring agent dispersion liquid 1 having a solid content of 21% is obtained.

(Preparation of Release Agent Dispersion Liquid 1)

| | |
|---|---|
| Paraffin wax: HNP-9 (trade name, produced by Nippon | 19 parts |
| Seiro K. K.): | |
| Anionic surfactant: NEOGEN SC (trade name, | 1 parts |
| produced by Dai-ichi Kogyo Seiyaku Co., Ltd.): | |
| Ion exchange water: | 80 parts |

The above components are mixed in a heat resistant vessel, heated to 90° C., followed by agitation for 30 min. Then, a melt solution was flowed from the vessel bottom to a golin homogenizer, processed by a cycle operation corresponding to three paths under a pressure of 5 MPa, the pressure is increased to 35 MPa, and further processed by a cycle operation corresponding to three paths. Thus obtained emulsified liquid is cooled in the heat resistant vessel to 40° C. or less, whereby a release agent dispersion liquid 1 is obtained.

(Preparation of Resin Dispersion Liquid 1)

(Oil Layer)

| | | |
|---|---|---|
| Styrene (produced by Wako Pure Chemical Industries, | 32 | parts |
| Ltd.): | | |
| N-butyl acrylate (produced by Wako Pure Chemical | 8 | parts |
| Industries, Ltd.): | | |
| β-carboxylethyl acrylate (produced by Rhodia | 1.3 | parts |
| Nikka Company): | | |
| Dodecane thiol (produced by Wako Pure Chemical | 0.4 | parts |
| Industries, Ltd.): | | |

(Water Layer 1)

| | | |
|---|---|---|
| Ion exchange water: | 17 | parts |
| Anionic surfactant (trade name: DOWFAX, produced by | 0.4 | parts |
| Dow Chemical Corporation) | | |

(Water Layer 2)

| | | |
|---|---|---|
| Ion exchange water: | 40 | parts |
| Anionic surfactant (trade name: DOWFAX, produced by | 0.05 | parts |
| Dow Chemical Corporation) | | |
| Ammonium peroxodisulfate (produced by Wako | 0.4 | parts |
| Pure Chemical Industries, Ltd.): | | |

The components of the above oil layer and the components of the above water layer 1 are put in a flask and mixed under agitation, so that a monomer emulsified dispersion liquid is obtained. To a reaction vessel, the components of the water layer 2 are added, and the inside of the vessel is sufficiently substituted with nitrogen. The reaction system is heated under agitation in an oil bath until the inside of the reaction system becomes 75° C. To the reaction vessel, the monomer emulsified dispersion liquid is gradually dropped over 3 hrs to perform emulsion polymerization. After the dropping comes to completion, the polymerization is continued at 75° C., and the polymerization is completed in 3 hrs later.

The volume average particle diameter D50 of the obtained fine resin particles is measured with a laser diffraction type particle size distribution analyzer LA-700 (trade name, produced by Horiba Ltd.,) and found to be 250 nm. The glass transition temperature is measured with a differential scanning calorimeter (trade name: DSC-50, produced by Shimadzu Corporation) at a temperature increase speed of 10° C./mini and found to be 52° C. Thus, the resin fine particle dispersion liquid having a volume average particle diameter of 250 inn, a solid content of 42% and a glass transition temperature of 52° C. is obtained.

| | |
|---|---|
| Fine resin particle dispersion liquid 1: | 150 parts |
| Coloring agent particle dispersion liquid 1: | 30 parts |
| Release agent particle dispersion liquid 1: | 40 parts |
| Polyaluminum chloride: | 0.4 parts |

The above components are sufficiently mixed and dispersed in a stainless flask with Ultra-Turrax (produced by IKA Corporation), and is heated to 48° C. under agitation in the flask, using a heating oil bath. After holding at 48° C. for 80 min, 70 parts of the same fine resin particle dispersion liquid as the above fine resin particle dispersion liquid is gradually added thereto. Thereafter, the pH of the system is adjusted to 6.0 with a 0.5 mol/L aqueous solution of sodium hydroxide, and the stainless flask is tightly sealed. The agitation axis is magnetically sealed, and the reaction system is heated to 97° C. under continued agitation and held at that state for 3 hrs. After the reaction comes to completion, the stainless flask is cooled at a temperature decrease rate of 1° C./min. The obtained product is filtered out and sufficiently washed with ion exchange water. Then a solid-liquid separation is conducted by nutche suction filteration. The obtained product is re-dispersed with 3 L of ion exchange water set at 40° C. and agitated and washed at 300 rpm for 15 min. The washing operation is further repeated five times. When the pH of the filtrate becomes 6.54 and the electric conductivity of the filtrate becomes 6.5 μS/cm, the solid-liquid separation is conducted with a No. 5A filter paper by a nutche suction filteration process. Then, vacuum drying is continued for 12 hrs, so that toner mother particles are obtained.

The volume average particle diameter D50v of the toner mother particles, as measured by Coulter Counter, is 6.2 μm and the volume average particle size distribution index GSDv is 1.20. When shape observation is performed with a Luzex image analyzer (produced by Luzex Corporation), the shape factor SF1 of the particles is found to be 135, which indicates potato-shaped particles. The glass transition temperature of the toner is 52° C. Furthermore, to the toner, silica (SiO₂) fine particles that are hydrophobicized by surface treatment with hexamethyldisilazane (hereinafter, in some cases, abbreviated as “HMDS”) and have an average primary particle diameter of 40 nm and metatitanate compound fine particles that are the reaction product of metatitanic acid and isobutyltrimethoxy silane and have an average primary particle diameter of 20 nm are added such that the coverage on the surface of respective colored particles is 40% and mixed by using a Henschel mixer, whereby a toner 1 is prepared.

### Example 1

The toner 1 and the carrier 1 are mixed such that the ratio of the toner 1 becomes 8%, and, thereby, a developer 1 is prepared.

(Evaluation)

The developer 1 is charged in DocuCenterColor400 manufactured by Fuji Xerox Co., Ltd. (modified device in which the speed of the developer holder is variable relative to the surface of the photoreceptor (latent image holding member) and an idle rotation of the developing unit before output is not performed), moved to an environment of 32° C. and 92% RH, and left in the environment for 8 hrs. Thereafter, a solid image in which the portion from an image edge to 10 cm from the image edge has a toner amount of 0.6 g/m² is prepared and the solid image is output on 10 sheets. The tenth sheet is taken as a standard.

In the next place, after being left in the same environment for two weeks, the solid image is output on one sheet, and used as a reference. The density of this solid image is compared to that of the above-mentioned standard. The fogging on the lower portion of the solid image is evaluated based on the criteria shown below. In the test, the ratio of the velocity of the surface of the photoreceptor to the velocity of the surface of the developer holder (velocity of the surface of the photoreceptor:velocity of the surface of the developer holder) is 1:2. Furthermore, the velocity of the surface of the photoreceptor and the velocity of the surface of the developer holder are obtained as follows. From the diameter L (cm) of the photoreceptor, the rotation number K (revolutions/min) of the photoreceptor, the diameter 1 (cm) of the developer holder and the rotation number r (revolutions/min) of the developer holder, the velocity of the surface of the photoreceptor is πL×R (cm/min) and the velocity of the developer holder is πl×r (cm/min). The evaluation of the fogging on the lower portion of the solid image and the evaluation of the density of the solid image are carried out as follows.

(Fogging on Lower Portion of Solid Image)

Fogging on the portion 1 cm from the rear edge of the solid image is confirmed visually and with a loupe (×20).

A—Fogging is observed neither visually nor with a loupe.
B—Fogging is not observed visually but observed with a loupe.
C—Fogging is only slightly observed visually, but the fogging is permissible.
D—Fogging is clearly observed visually.

Levels A to C are assumed to be allowable. The results are shown in Table 1.

(Density of Solid Image)

The density of the solid portions of the standard and the reference are measured with an image densitometer (trade name: X-RITE 404A, produced by X-Rite Corporation). The density of the reference is expressed by % assuming that the density of the standard is 100%. A value closer to 100% is better. A target is set at 85% and samples giving less than 85% are evaluated as problematic. The results are shown in Table 1.

### Examples 2 to 16 and Comparative Examples 1 and 2

Developers 2 to 18 are prepared in the same way as in example 1 except that the carrier 1 is changed to the carriers 2 to 18, respectively, as shown in Table 1. These developers were evaluated in the same way as in example 1. The results are shown in Table 1.

### Examples 17 to 21

The evaluation is conducted in the same way as in example 9 except that the ratio of the velocity of the photoreceptor surface to the velocity of the developer holder is changed to 1:1.4 (Example 17), 1:1.5 (Example 18), 1:4 (Example 19), 1:5 (Example 20) and 1:5.1 (Example 21), respectively. The results are shown in Table 1. In Table 1, “cyclohexyl series” described in the column of coating resin means a polycyclohexyl methacrylate resin (produced by Soken Chemical & Engineering Co., Ltd., weight average molecular weight: 65000) and “methyl series” means a polymethyl methacrylate resin (produced by Soken Chemical & Engineering Co., Ltd., weight average molecular weight: 75000).

TABLE 1

| | | Carbon Black | | | | Speed Ratio of | | |
|---|---|---|---|---|---|---|---|---|
| | | or Nigrosine | | Acid Having | | Surface of | Evaluation Results | |
| | | | Particle | Cyclic | | Developer Holder | Fogging on | Density of |
| | Kind of | | Diameter | Diterpene | | to Photoreceptor | Lower Portion | Solid Image |
| | Carrier | Kind | (μm) | Structure | Coating resin | Surface | of Solid Image | (%) |
| Ex. 1 | Carrier 1 | Carbon Black 1 | 0.11 | Abietic Acid | Cyclohexyl Series | 1:2 | A | 90 |
| Ex. 2 | Carrier 2 | Carbon Black 2 | 0.22 | Abietic Acid | Cyclohexyl Series | 1:2 | A | 90 |
| Ex. 3 | Carrier 3 | Carbon Black 3 | 0.57 | Abietic Acid | Cyclohexyl Series | 1:2 | A | 90 |
| Ex. 4 | Carrier 4 | Carbon Black 4 | 0.84 | Abietic Acid | Cyclohexyl Series | 1:2 | B | 86 |
| Ex. 5 | Carrier 5 | Carbon Black 5 | 1.10 | Abietic Acid | Cyclohexyl Series | 1:2 | C | 85 |
| Ex. 6 | Carrier 6 | Carbon Black 6 | 0.15 | Pimaric Acid | Cyclohexyl Series | 1:2 | A | 88 |
| Ex. 7 | Carrier 7 | Carbon Black 7 | 0.18 | Neoabietic Acid | Cyclohexyl Series | 1:2 | A | 87 |
| Ex. 8 | Carrier 17 | Carbon Black 1 | 0.11 | Abietic Acid | Methyl Series | 1:2 | B | 86 |
| Ex. 9 | Carrier 9 | Nigrosine 1 | 0.10 | Abietic Acid | Cyclohexyl Series | 1:2 | A | 89 |
| Ex. 10 | Carrier 10 | Nigrosine 2 | 0.18 | Abietic Acid | Cyclohexyl Series | 1:2 | A | 92 |
| Ex. 11 | Carrier 11 | Nigrosine 3 | 0.46 | Abietic Acid | Cyclohexyl Series | 1:2 | A | 93 |
| Ex. 12 | Carrier 12 | Nigrosine 4 | 0.77 | Abietic Acid | Cyclohexyl Series | 1:2 | B | 90 |
| Ex. 13 | Carrier 13 | Nigrosine 5 | 0.91 | Abietic Acid | Cyclohexyl Series | 1:2 | C | 87 |
| Ex. 14 | Carrier 14 | Nigrosine 6 | 0.12 | Pimaric Acid | Cyclohexyl Series | 1:2 | A | 90 |
| Ex. 15 | Carrier 15 | Nigrosine 7 | 0.14 | Neoabietic Acid | Cyclohexyl Series | 1:2 | A | 90 |
| Ex. 16 | Carrier 18 | Nigrosine 1 | 0.11 | Abietic Acid | Methyl Series | 1:2 | B | 88 |
| Ex. 17 | Carrier 9 | Nigrosine 1 | 0.10 | Abietic Acid | Cyclohexyl Series | 1:1.4 | A | 86 |
| Ex. 18 | Carrier 9 | Nigrosine 1 | 0.10 | Abietic Acid | Cyclohexyl Series | 1:1.5 | A | 90 |
| Ex. 19 | Carrier 9 | Nigrosine 1 | 0.10 | Abietic Acid | Cyclohexyl Series | 1:4 | A | 95 |
| Ex. 20 | Carrier 9 | Nigrosine 1 | 0.10 | Abietic Acid | Cyclohexyl Series | 1:5 | B | 96 |
| Ex. 21 | Carrier 9 | Nigrosine 1 | 0.10 | Abietic Acid | Cyclohexyl Series | 1:5.1 | C | 97 |
| Comp. | Carrier 8 | Carbon black 8 | 1.90 | None | Cyclohexyl Series | 1:2 | D | 90 |
| Ex. 1 | | | | | | | | |
| Comp. | Carrier 16 | Nigrosine 8 | 1.50 | None | Cyclohexyl Series | 1:2 | D | 93 |
| Ex. 2 | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing carrier, comprising:
a magnetic particle; and
a resin coating layer that covers a surface of the magnetic particle with a resin,
the resin coating layer containing an acid having a cyclic diterpene structure and either of carbon black or nigrosine dispersed therein.

2. The electrostatic charge image developing carrier of claim 1, wherein the relationship between the number average particle diameter of the carbon black d₁ (μm) and the mean spacing of profile irregularities on the surface of the magnetic particle Sm satisfies 0.4Sm (or about 0.4Sm)≦d₁≦2Sm (or about 2Sm).

3. The electrostatic charge image developing carrier of claim 1, wherein the number average particle diameter of the carbon black is from 0.1 μm (or about 0.1 μm) to 1 μm (or about 1 μm).

4. The electrostatic charge image developing carrier of claim 1, wherein the relationship between the number average particle diameter of the nigrosine d₂ (μm) and the mean spacing of profile irregularities on the surface of the magnetic particle Sm satisfies 0.25Sm (or about 0.25Sm)≦d₂≦2Sm (or about 2Sm).

5. The electrostatic charge image developing carrier of claim 1, wherein the number average particle diameter of the nigrosine is from 0.1 μm (or about 0.1 μm) to 0.8 μm (or about 0.8 μm).

6. The electrostatic charge image developing carrier of claim 1, wherein the saturation magnetization of the magnetic particle in a magnetic field of 3000 Oe is 50 emu/g (or about 50 emu/g) or more.

7. The electrostatic charge image developing carrier of claim 1, wherein the volume resistance (volume resistivity) of the magnetic particle is from 10⁵ Ω·cm (or about 10⁵ Ω·cm) to 10^{9.5} Ω·cm (or about 10^{9.5} Ω·cm).

8. The electrostatic charge image developing carrier of claim 1, wherein the acid having a cyclic diterpene structure contains at least one selected from the group consisting of abietic acid, neoabietic acid, pimaric acid and dehydrosapietic acid.

9. The electrostatic charge image developing carrier of claim 1, wherein the resin covering the surface of the magnetic particle contains a resin having a cycloalkyl group at a side chain.

10. The electrostatic charge image developing carrier of claim 9, wherein the resin having a cycloalkyl group at a side chain contains at least one selected from the group consisting of cyclohexyl acrylate, cyclohexyl methacrylate and cyclohexyl ethacrylate.

11. The electrostatic charge image developing carrier of claim 1, wherein a proportion of the surface of the magnetic particle covered by the resin coating layer is 95% (or about 95%) or more.

12. The electrostatic charge image developing carrier of claim 1, wherein the average film thickness of the resin coating layer is from 0.1 μm (or about 0.1 μm) to 10 μm (or about 10 μm).

13. The electrostatic charge image developing carrier of claim 1, wherein a shape factor SF1 of the electrostatic charge image developing carrier is from 120 (or about 120) to 145 (or about 145).

14. The electrostatic charge image developing carrier of claim 1, wherein the saturation magnetization of the electrostatic charge image developing carrier in a magnetic field of 1000 Oe is 40 emu/g (or about 40 emu/g) or more.

15. The electrostatic charge image developing carrier of claim 1, wherein the volume resistance (at 25° C.) of the electrostatic charge image developing carrier is from 1×10⁷ Ω·cm (or about 1×10⁷ Ω·cm) to 1×10¹⁵Ω·cm (or about 1×10⁵ Ω·cm).

16. An electrostatic charge image developer, comprising:
a toner; and
the electrostatic charge image developing carrier of claim 1.

17. The electrostatic charge image developer of claim 16, wherein a ratio of toner particles in the toner having a particle diameter of 16 μm or more is 1.0% by volume (or about 1.0% by volume) or less.

18. An image forming method, comprising at least:
charging a surface of a latent image holding member;
forming an electrostatic latent image on the charged surface of the latent image holding member;
developing the electrostatic latent image formed on the surface of the latent image holding member as a toner image using a developer containing a toner;
transferring the toner image from the surface of the latent image holding member to a recording medium; and
fixing the toner image that has been transferred onto the recording medium,
the developer being the electrostatic charge image developer of claim 16.

19. The image forming method of claim 18, wherein a speed ratio between the surface of the latent image holding member and a surface of a developer holder in the developing is from 1:1.5 (or about 1:1.5) to 1:5 (or about 1:5).

20. An electrostatic charge image developer cartridge that is attachable to and detachable from an image forming apparatus, the image forming apparatus comprising at least:
a latent image holding member;
a developing unit that develops an electrostatic latent image formed on a surface of the latent image holding member as a toner image using a developer containing a toner; and
a transfer unit that transfers the toner image from the surface of the latent image holding member to a recording medium,
the cartridge storing the developer that is supplied to the developing unit, and
the developer being the electrostatic charge image developer of claim 16.

21. A process cartridge that is attachable to and detachable from an image forming apparatus, the image forming apparatus comprising at least:
a latent image holding member; and
a developing unit that develops an electrostatic latent image formed on a surface of the latent image holding member as a toner image using a developer containing a toner,
the developer being the electrostatic charge image developer of claim 16.

22. An image forming apparatus, comprising at least:
a latent image holding member;
a developing unit that develops an electrostatic latent image formed on a surface of the latent image holding member as a toner image using a developer containing a toner;
a transfer unit that transfers the toner image from the surface of the latent image holding member to a recording medium; and
a fixing unit that fixes the toner image that has been transferred onto the recording medium;
the developer being the electrostatic charge image developer of claim 16.

23. The image forming apparatus of claim 22, wherein a speed ratio between the surface of the latent image holding member and a surface of a developer holder in the developing unit is from 1:1.5 (or about 1:1.5) to 1:5 (or about 1:5).

24. The image forming apparatus of claim 23, wherein a peripheral speed of the developer holder is 400 mm/s or more.
